(19) United States
(12) Patent Application Publication
(10) Pub. No.: US 2012/0077075 A1
(43) Pub. Date: Mar. 29, 2012

(54) STACK TYPE BATTERY

(75) Inventors: Yuji Tani, Sumoto-shi (JP); Hitoshi Maeda, Sumoto-shi (JP); Masayuki Fujiwara, Kasai-shi (JP); Masao Kusukawa, Sumoto-shi (JP); Yoshitaka Shinyashiki, Kobe-shi (JP); Atsuhiro Funahashi, Toyonaka-shi (JP)

(73) Assignee: SANYO ELECTRIC CO., LTD., Osaka (JP)

(21) Appl. No.: 13/242,028

(22) Filed: Sep. 23, 2011

(30) Foreign Application Priority Data
Sep. 24, 2010 (JP) 2010-213179

(51) Int. Cl. H01M 10/02; H01M 6/46

(52) U.S. Cl. 429/153

(57) ABSTRACT

A stack type battery has a stacked electrode assembly (10) in which a plurality of positive electrode plates (1) and a plurality of negative electrode plates (2) are alternately stacked one another across separators. Each one of pairs of the separators adjacent to each other in a stacking direction has a bonded portion (4) in which the separators are bonded to each other in at least a portion of a perimeter portion thereof, so as to form a pouch-type separator (3). The proportion of the bonded portion (4) of one of the pouch-type separators 3 (low blocking rate pouch-type separator (3L)) located in a stacking direction-wise central region of the stacked electrode assembly (10) is made smaller than the proportion of the bonded portion (4) of each of the pouch-type separators 3 (high blocking rate pouch-type separator 3H) located in both stacking direction-wise end portions of the stacked electrode assembly (10).

### BACKGROUND OF THE INVENTION

1. Field of the Invention

The present invention relates to stack type batteries, and more particularly to high capacity stack type batteries used as power sources for, for example, robots, electric vehicles, and backup power sources. Still more particularly, the invention relates to a secondary battery having a stacked electrode assembly using a pouch-type separator.

2. Description of Related Art

In recent years, batteries have been used for not only the power source of mobile information terminal devices such as mobile-phones, notebook computers, and PDAs but also for such applications as robots, electric vehicles, and backup power sources. This has led to a demand for higher capacity batteries. Because of their high energy density and high capacity, lithium-ion batteries are widely used as the power sources for such applications as described above.

The battery configurations of the lithium-ion batteries are broadly grouped into two types: one is a spirally-wound type lithium-ion battery, in which a spirally wound electrode assembly is enclosed in a battery case, and the other is a stack type lithium-ion battery (stack-type prismatic lithium ion battery), in which a stacked electrode assembly comprising a plurality of stacks of rectangular-shaped electrodes is enclosed in a battery can or a laminate battery case prepared by welding laminate films together.

Of the above-described lithium ion secondary batteries, the stack type lithium-ion battery has a stacked electrode assembly having the following structure. The stacked electrode assembly has a required number of sheet-shaped positive electrode plates each having a positive electrode current collector lead and a required number of sheet-shaped negative electrode plates each having a negative electrode current collector lead protruding therefrom. The positive electrode plates and the negative electrode plates are stacked with separators made of polyethylene, polypropylene, or the like and interposed between the positive and negative electrode plates.

Conventionally, the just-described stack type battery is constructed in the following manner. Two sheets of separator are bonded at their peripheral portions to form a pouch, and in this pouch-type separator, either one of the positive electrode plate and the negative electrode plate is enclosed. Then, the pouch-type separator enclosing the positive electrode plate or the negative electrode plate is alternately stacked on a negative electrode plate or a positive electrode plate that is not enclosed in a pouch-type separator, to construct a stacked electrode assembly. With this structure, short circuiting between the positive electrode plates and the negative electrode plates can be prevented effectively.

However, a problem with this structure, in which the positive electrode plate or the negative electrode plate is enclosed in the pouch-type separator, is that the electrolyte solution is difficult to permeate into the internal electrode plate. Although the polyethylene sheet or the polypropylene sheet, for example, which is commonly used as the separator, is a porous membrane, the electrolyte solution is difficult to infiltrate into the inside through the pores of the porous membrane unlike the case of, for example, a separator made of nonwoven fabric.

In view of the problem, Japanese Published Unexamined Patent Application No. 09-129211 (1997), for example, discloses that an electrolyte passage port is provided in at least one side of a pouch-type separator. Also, Japanese Published Unexamined Patent Application No. 05-144427 (1993) discloses that unwelded portions and welded portions are provided alternately in a pouch-type separator. With such constructions, the electrolyte solution is allowed to easily infiltrate into the internal electrode plate through the electrolyte passage port or the unwelded portions, while preventing short circuiting between the positive electrode plate and the negative electrode plate by the pouch-type separator.

Another problem with the above-described stack type battery also has been that the electrolyte solution is difficult to permeate into the electrode plate enclosed in a pouch-type separator located at the stacking direction-wise center of the stacked electrode assembly. This problem is especially serious when the number of the stacks is large or when the electrode plate area is large. This problem leads to unevenness in the distribution of the electrolyte solution among the electrode plates in the stacked electrode assembly, resulting in unevenness in the amount of the surface film formed on the negative electrode during pre-charge and non-uniform reactions during charge and discharge. As a consequence, the cycle life degradation occurs. Thus, neither Japanese Published Unexamined Patent Application Nos. 09-129211 (1997) nor 05-144427 (1993) addresses the problem of uneven distribution of the electrolyte solution across the stacking direction of the stacked electrode assembly.

### BRIEF SUMMARY OF THE INVENTION

In view of the foregoing and other problems, it is an object of the present invention to provide a stack type battery that can effectively uniformize the distribution of the electrolyte solution in a stacking direction of the stacked electrode assembly.

In order to accomplish the foregoing and other objects, the present invention provides a stack type battery, comprising:

a stacked electrode assembly comprising a plurality of positive electrode plates having respective positive electrode current collector tabs protruding therefrom, a plurality of negative electrode plates having respective negative electrode current collector tabs protruding therefrom, and separators interposed between the positive electrode plates and the negative electrode plates, the positive electrode plates and the negative electrode plates being alternately stacked one another across the separators; wherein:

each one of pairs of the separators adjacent to each other in a stacking direction has a bonded portion in which the adjacent separators are bonded to each other in at least a portion of a perimeter portion thereof; and

the proportion of the bonded portion of one of the separators located in a stacking direction-wise central region of the stacked electrode assembly is smaller than the proportion of the bonded portion of each of the separators located in both stacking direction-wise end portions of the stacked electrode assembly.

The present invention makes it possible to uniformize the distribution of the electrolyte solution across the stacking direction of the stacked electrode assembly in the stack type battery effectively.

### BRIEF DESCRIPTION OF THE DRAWINGS

FIG. 1 shows portions of a stack type battery according to the present invention, wherein FIG. 1(a) is a plan view illustrating a positive electrode plate thereof, FIG. 1(b) is a plan view illustrating a separator thereof, and FIG. 1(c) is a plan view illustrating a pouch-type separator thereof in which a positive electrode is disposed;

FIG. 2 is a plan view illustrating a negative electrode plate used for the stack type battery of the present invention;

FIGS. 3(a) and 3(b) show plan views illustrating a low blocking rate pouch-type separator and a high blocking rate pouch-type separator, respectively;

FIG. 4 is an exploded perspective view illustrating a stacked electrode assembly used for the stack type battery according to the present invention;

FIG. 5 is a plan view illustrating the stacked electrode assembly used for the stack type battery according to the present invention;

FIG. 6 is a plan view illustrating how positive and negative electrode tabs and positive and negative electrode current collector terminals are welded together;

FIG. 7 is a perspective view illustrating a laminate battery case in which the stacked electrode assembly is enclosed; and

FIG. 8 is a graph illustrating the dispersibility of the electrolyte solution in a present invention battery and comparative batteries.

### DETAILED DESCRIPTION OF THE INVENTION

A stack type battery of the present invention comprises: a stacked electrode assembly comprising a plurality of positive electrode plates having respective positive electrode current collector tabs protruding therefrom, a plurality of negative electrode plates having respective negative electrode current collector tabs protruding therefrom, and separators interposed between the positive electrode plates and the negative electrode plates, the positive electrode plates and the negative electrode plates being alternately stacked one another across the separators; wherein: each one of pairs of the separators adjacent to each other in a stacking direction has a bonded portion in which the adjacent separators are bonded to each other in at least a portion of a perimeter portion thereof; and the proportion of the bonded portion of one of the separators located in a stacking direction-wise central region of the stacked electrode assembly is smaller than the proportion of the bonded portion of each of the separators located in both stacking direction-wise end portions of the stacked electrode assembly.

In the present invention, the method of bonding used for the bonded portion of the separators is not particularly limited. Examples include welding such as thermal welding and ultrasonic welding, and bonding with an adhesive agent.

The phrase “the proportion of the bonded portion of a separator” means the proportion of the length of the bonded region in the perimeter portion of the separator with respect to the total length of the perimeter portion of the separator.

The embodiment in which “each one of pairs of the separators adjacent to each other in a stacking direction has a bonded portion in which the adjacent separators are bonded to each other” may be, for example, one in which two square-shaped separators are stacked on each other and their perimeter portions are bonded to each other to form a pouch shape, and one in which one square-shaped separator is folded over at its central portion and its side portions are bonded to each other to form a pouch shape. In the latter case, the folded-over portion is not included in “the region of the bonded portion.”

The term “one of the separators located in a stacking direction-wise central region of the stacked electrode assembly” means at least one of the separators other than the separators located in both stacking direction-wise end portions. Accordingly, the scope of the present invention includes, for example, an embodiment in which the proportion of the bonded portion of all the separators other than the separators located in both stacking direction-wise end portions is smaller than the proportion of the bonded portion of each of the separators located in both stacking direction-wise end portions, and an embodiment in which the proportion of the bonded portion of the separators decreases gradually or step by step from the separators located in both stacking direction-wise end portions toward the center.

The term “each of the separators located in both stacking direction-wise end portions” means each of the separators that are located in two stacking direction-wise outermost locations, among the pairs of the adjacent separators that are bonded to each other. In the stacked electrode assembly, there may be a case in which unbonded sheet-shaped separators are disposed for the stacking direction-wise outermost portions (both end portions), but these sheet-shaped separators do not fall into the category of “the separators located in both stacking direction-wise end portions” in the present invention.

With the above-described configuration of the present invention, the proportion of the bonded portion (i.e., the welded portion) is large in the separators located in the stacking direction-wise upper stacks and lower stacks (both stacking direction-wise end portions) of the stacked electrode assembly, in which the electrolyte solution easily permeates normally, while the proportion of the bonded portion (i.e., the welded portion) is small in the separators located in the stacking direction-wise central portion of the stacked electrode assembly, in which the electrolyte solution is normally difficult to permeate. As a result, unevenness of the permeability of the electrolyte solution along the stacking direction is alleviated, and the distribution of the electrolyte solution is uniformized. In other words, the electrolyte permeation in the stacked electrode assembly is uniformized across the stacking direction effectively.

It is preferable that the proportion of the bonded portion (i.e., the welded portion) of the one of the separators located in the stacking direction-wise central region of the stacked electrode assembly be less than 50%.

With the above-described configuration, the permeability of the electrolyte solution is sufficient in the stacking direction-wise central region of the stacked electrode assembly. As a result, unevenness of the permeability of the electrolyte solution along the stacking direction can be alleviated effectively.

It is desirable that the stacking direction-wise central region of the stacked electrode assembly deviate from the stacking direction-wise center toward one stacking direction-wise end of the stacked electrode assembly.

The present inventors have found the following problem in a manufacturing process of the stack type battery. That is, when the battery is held in a horizontal orientation (the orientation in which the stacking direction is a vertical direction), the electrolyte solution is difficult to permeate into the electrode plate (the electrode plate enclosed in a pouch-type separator) located in a region slightly above the center of the stacked electrode assembly after filling the electrolyte solution.

The details of this condition are believed to be as follows. After filling the electrolyte solution, the electrolyte solution is difficult to infiltrate into the central portion of the stacked electrode assembly, although the electrolyte solution easily infiltrates into the perimeter portion of the stacked electrode assembly. Thereafter, when the battery is placed in a horizontal orientation, the electrolyte solution existing between the stacked electrode assembly and the battery case moves downward because of the gravitational force. As a result, the electrolyte solution can easily infiltrate in the electrode plates existing in a lower region than the stacking direction-wise center of the stacked electrode assembly. In upper stacks of the stacked electrode assembly, the electrolyte solution is trapped between the battery case and the stacked electrode assembly, so the electrolyte solution also easily infiltrates into the upper stacks. In contrast, the electrolyte solution is still difficult to permeate into the electrode plates located in a region slightly above the stacking direction-wise center of the stacked electrode assembly.

The inventors have found that the foregoing problem can be resolved by positioning the central region, which uses the separator in which the proportion of the bonded portion (the welded portion) is small, to be slightly above the stacking direction-wise center of the stacked electrode assembly.

However, whether the region that uses the separator with a small proportion of the bonded portion (the welded portion) is positioned in a stacking direction-wise upper side or in a stacking direction-wise lower side of the stacked electrode assembly varies depending on how the battery is placed. For this reason, it is recommended to employ the configuration in which the stacking direction-wise central region deviates from the stacking direction-wise center of the stacked electrode assembly toward stacking direction-wise one end of the stacked electrode assembly, as described above.

It is desirable that the proportion of the bonded portion of one of the separators located in at least a portion of a 20-65% region, more preferably in a 20-60% region, or still more preferably in a 25-50% region, of the stacked electrode assembly from one stacking direction-wise end thereof should be smaller than the proportion of each of the bonded portions of the separators located in a region other than the 20-65% region, the 20-60% region, or the 25-50% region.

It is also possible that the proportion of the bonded portion of all the separators located in the foregoing ranges, i.e., in the 20-65% region, in the 20-60% region, or in the 25-50% region, may be set smaller than the proportion of each of the bonded portions of the separators located in the region other than the foregoing ranges.

In the present invention, the term “x-y %” as in “the x-y % region of the stacked electrode assembly from one end portion” refers to the proportion calculated based on the number of the separators in the stacked electrode assembly.

In addition, the term “the number of the separators” means the number of pairs of the separators adjacent to each other and bonded to each other, and when unbonded sheet-shaped separators are disposed for the stacking direction-wise outermost portions (both end portions) of the stacked electrode assembly, the number of the sheet-shaped separators is not counted as part of the number of the separators.

In the 20-65% region, particularly the 20-60% region, more particularly the 25-50% region from one stacking direction-wise end of the stacked electrode assembly, the electrolyte solution is especially difficult to permeate when the battery is held in a horizontal orientation while setting the one end of the stacked electrode assembly to be the upper side. Therefore, when the proportion of the bonded portion of the separators located in this region is made smaller than the proportion of the bonded portion of the separators located in a region other than the 20-65% region, particularly the 20-60% region, or more particularly the 25-50% region, the electrolyte permeation can be uniformized across the stacking direction of the stacked electrode assembly effectively.

It is desirable that the stacked electrode assembly be accommodated in a battery case having flexibility, for example, in a laminate battery case made of a laminate film.

The battery case for enclosing the stacked electrode assembly is not particularly limited, and it may be a battery can, for example. However, when using a battery case that is flexible, especially when using a laminate battery case made of a laminate film, it is possible to design, for example, the electrode plate area, the shape of the tabs, or the battery shape freely. Another advantage of the battery using a laminate battery case is that it is easy to place the battery in a horizontal orientation, and therefore, the advantageous effects of the present invention are especially significant. The battery using a can as the battery case is rarely held in a horizontal orientation. On the other hand, for the battery using a laminate battery case, holding the battery in a horizontal orientation is the easiest way to retain the battery.

Examples of the laminate battery case include one in which two sheets of laminate are used and four sides of the sheets are sealed, and one in which one sheet of laminate is folded over at its central portion and the three sides except for the fold-over portion are sealed.

Further examples of the laminate battery case include one in which a pair of laminate films each shaped into a substantially cup shape are opposed and bonded to each other in a symmetrical shape so as to have an inner cavity portion for accommodating the stacked electrode assembly, and one in which a laminate film formed into a substantially cup shape having a recessed portion for accommodating the stacked electrode assembly is bonded to a sheet-shaped laminate film, so as to have an asymmetrical shape. When employing, of the just-described examples of the laminate battery case, the laminate battery case comprising a cup-shaped portion and a sheet-shaped portion (one in an asymmetrical shape) and also employing a configuration in which the stacking direction-wise central region deviates from the stacking direction-wise center of the stacked electrode assembly toward stacking direction-wise one end of the stacked electrode assembly, it is possible to employ the following two kinds of configurations: one in which the stacking direction-wise one end, i.e., the side toward which the region using the separator having a smaller proportion of the bonded portion (welded portion) is shifted, is the cup-shaped portion side, and one in which the stacking direction-wise one end is the sheet-shaped portion side.

1) The configuration in which the central region is shifted toward the cup-shaped portion side.

This configuration is suitable when the cup-shaped portion is the upper side. An advantage is that the battery tends to be more stable when it is placed in a horizontal orientation after filling the electrolyte solution.

2) The configuration in which the central region is shifted toward the sheet-shaped portion side.

This configuration is suitable when the sheet-shaped portion is the upper side. An advantage is that contacting of the lead tabs and the ground surface (the surface on which the battery is placed) can be prevented more easily. If the lead tabs and the ground surface (the surface on which the battery is placed) make contact with each other, short circuiting may occur.

It is desirable that each of the positive electrode plates has an area of 200 cm² or greater.

When the positive electrode plate is a large-sized one having an area of 200 cm² or greater, the negative electrode plate is accordingly a large-sized one having an area that is the same as or greater than the positive electrode plate. However, when the electrode plate is a large-sized one having an area of 200 cm² or greater, the electrolyte solution tends to be more difficult to permeate into the electrode plates located at the stacking direction-wise center of the stacked electrode assembly. Therefore, the advantageous effects of the present invention are exhibited particularly significantly, in which the proportion of the region of the bonded portion of the separator located in a stacking direction-wise central region is set smaller than the proportion of the region of the bonded portion of the separators located in both stacking direction-wise end portions of the stacked electrode assembly.

It is desirable that the bonded portions be formed by welding.

The method of bonding the separators to each other may be, for example, bonding by an adhesive agent. However, when welding is employed, the separators can be bonded to each other easily and at low cost, and moreover, the ratio of the welded portion and the unwelded portion can be determined easily.

The electrode plate disposed between the separators that are bonded to each other (i.e., the electrode plate enclosed inside the pouch-type separator) may be a positive electrode plate or a negative electrode plate. However, in reality, a positive electrode plate is desirable. The negative electrode plate needs to have a greater area than the positive electrode plate, and on the other hand, the pouch-type separator needs to have a greater area than the electrode plate to be enclosed therein because its perimeter portion must be bonded together. For this reason, the size of the pouch-type separator can be kept smaller when a positive electrode plate is enclosed in the pouch-type separator than when a negative electrode plate is enclosed therein.

It is desirable to use an electrolyte solution having a viscosity of 2.0 mPa·s or greater as the electrolyte solution.

When the viscosity of the electrolyte solution is 2.0 mPa·s or greater, the electrolyte solution tends to be more difficult to permeate into the electrode plates located in the stacking direction-wise central portion of the stacked electrode assembly. For this reason, the advantageous effects of the present invention are exhibited particularly significantly, in which the proportion of the bonded portion of each of the separators located in the stacking direction-wise central region of the stacked electrode assembly is set smaller than the proportion of each of the bonded portions of the separators located in both stacking direction-wise end portions of the stacked electrode assembly.

### DESCRIPTION OF EMBODIMENTS

Hereinbelow, with reference to the drawings, the present invention is described in further detail based on certain embodiments and examples thereof. It should be construed, however, that the present invention is not limited to the following embodiments and examples, and various changes and modifications are possible without departing from the scope of the invention.

### Preparation of Positive Electrode

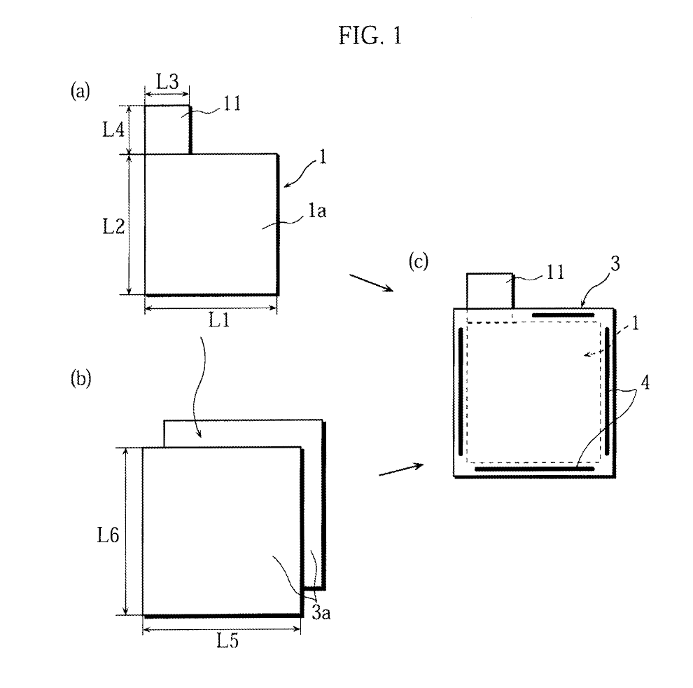

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Thereafter, the material was dried by heating to remove the solvent and compressed with rollers to a thickness of 0.1 mm. Subsequently, as illustrated in FIG. 1(a), it was cut into pieces each having a width L1 of 145 mm and a height L2 of 150 mm, to prepare positive electrode plates 1 each having a positive electrode active material layer la on each side of the aluminum foil. At this point, in each of the positive electrode plates 1, an aluminum foil on which the positive electrode active material layer 1a was not formed, which had a width L3=30 mm and a height L4=20 mm, was allowed to protrude outwardly from one end (the left end in FIG. 1(a)) of one side of the positive electrode plate 1 that extends along the width L1, to form a positive electrode current collector tab 11.

### Preparation of Negative Electrode

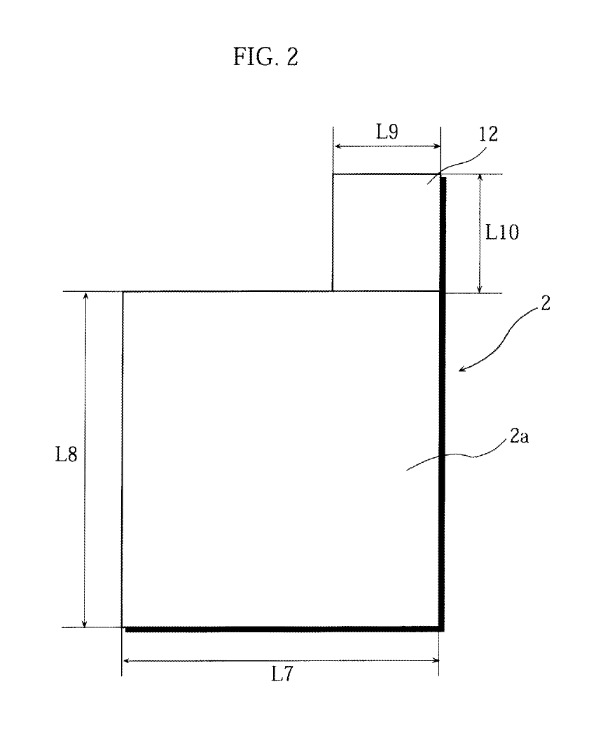

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Thereafter, the material was dried to remove the solvent and compressed with rollers to a thickness of 0.08 mm. Subsequently, as illustrated in FIG. 2, it was cut into pieces each having a width L7 of 150 mm and a height L8 of 155 mm, to prepare negative electrode plates 2 each having a negative electrode active material layer 2a on each side of the copper foil. At this point, in each of the negative electrode plates 2, a copper foil on which the negative electrode active material layer 2a was not formed, having a width L9 of 30 mm and a height L10 of 20 mm, was allowed to protrude outwardly from one end (the right end in FIG. 2) of the negative electrode plate 2 that is opposite to the side end thereof at which the positive electrode tab 11 was formed, in one side of the negative electrode plate 2 that extends along the widthwise direction, to form a negative electrode tab 12.

Preparation of Pouch-Type Separator in which the Positive Electrode Plate is Disposed

A positive electrode plate 1 was disposed between two square-shaped polypropylene (PP) separators 3a (thickness: 30 μm) each having a width L5 of 150 mm and a height L6 of 155 mm as illustrated in FIG. 1(b). Thereafter, as illustrated in FIG. 1(c), the peripheral portions of the separators 3a were thermally welded and bonded to form bonded portions 4 extending along the respective sides, to prepare a pouch-type separator 3, in which the positive electrode plate 1 was accommodated.

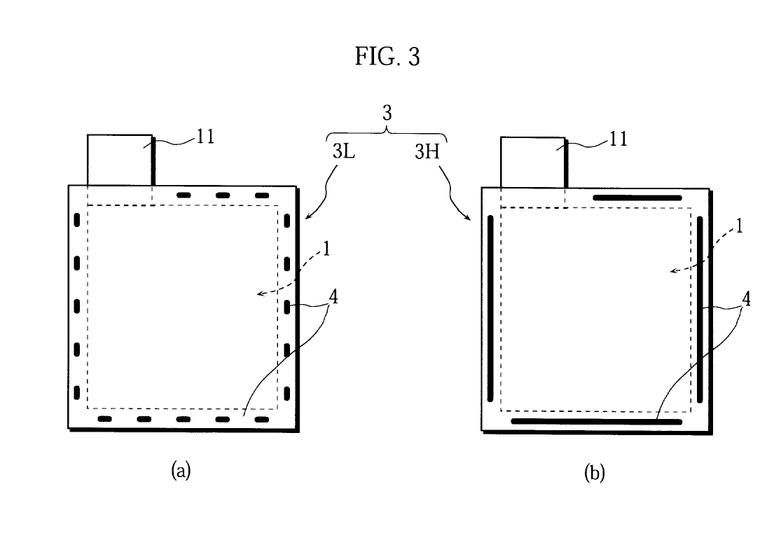

At this point, as illustrated in FIG. 3, the proportion of the regions of the bonded portions 4 of the separator 3a was varied to prepare the following two kinds of pouch-type separators 3L and 3H.

1) As illustrated in FIG. 3(a), the proportion of the length of the bonded portions 4 with respect to the length of the perimeter portion of the separator 3a was set to 30%. Hereinafter, this kind of separator is also referred to as a “low blocking rate pouch-type separator 3L.”

2) As illustrated in FIG. 3(b), the proportion of the length of the bonded portions 4 with respect to the length of the perimeter portion of the separator 3a was set to 80% or less. Hereinafter, this kind of separator is also referred to as a “high blocking rate pouch-type separator 3H.”

### Preparation of Stacked Electrode Assembly

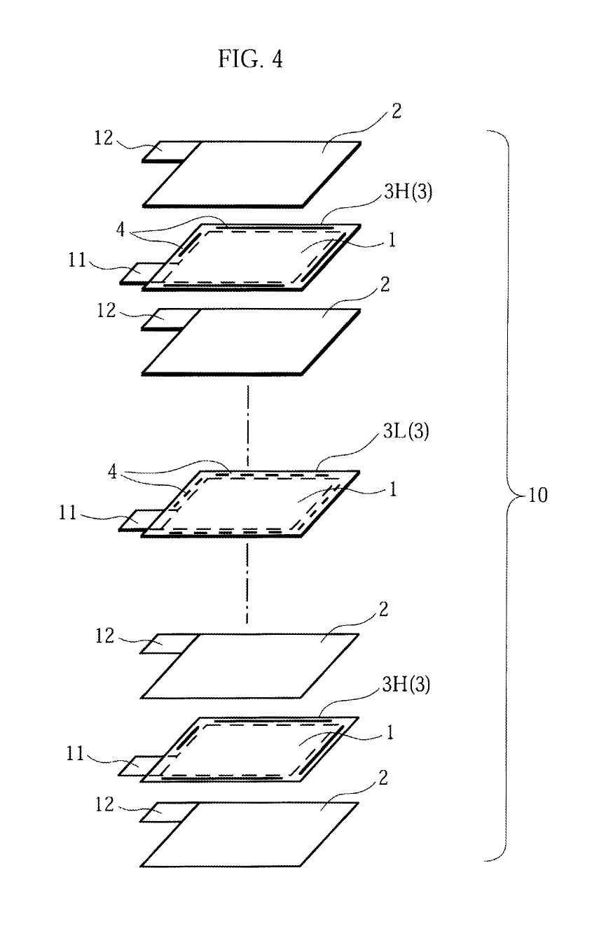

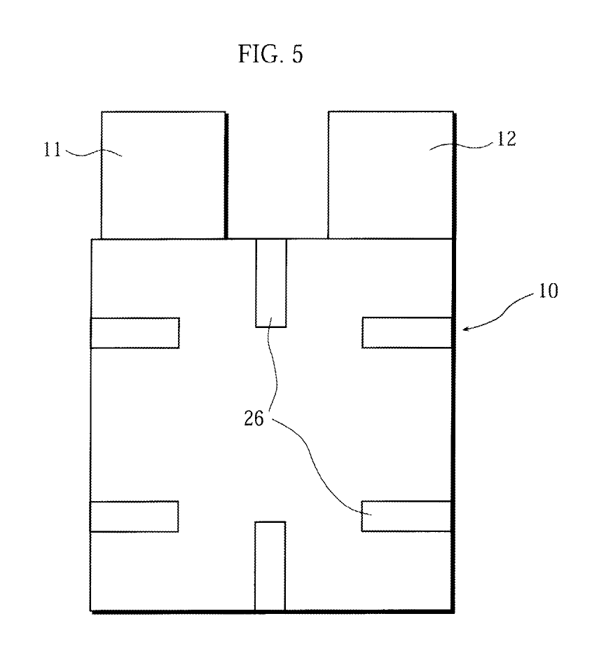

25 sheets of the pouch-type separators 3 in each of which the positive electrode plate 1 was disposed and 26 sheets of the negative electrode plates 2 were prepared, and the pouch-type separators 3 and the negative electrode plates 2 were alternately stacked one on the other, as illustrated in FIG. 4. Then, negative electrode plates 2 were located at both stacking direction-wise ends of the stack. Also in this process, the high blocking rate pouch-type separators 3H were placed in the first to fourth stacks and the 16th to 25th stacks from the top of the stacked electrode assembly 10 along the stacking direction, and the low blocking rate pouch-type separators 3L were placed in the fifth to 15th stacks. Subsequently, as illustrated in FIG. 5, the top and bottom faces of the stacked component were connected by insulating tapes 26 for retaining its shape. Thus, a stacked electrode assembly 10 was obtained.

### Welding of Current Collectors

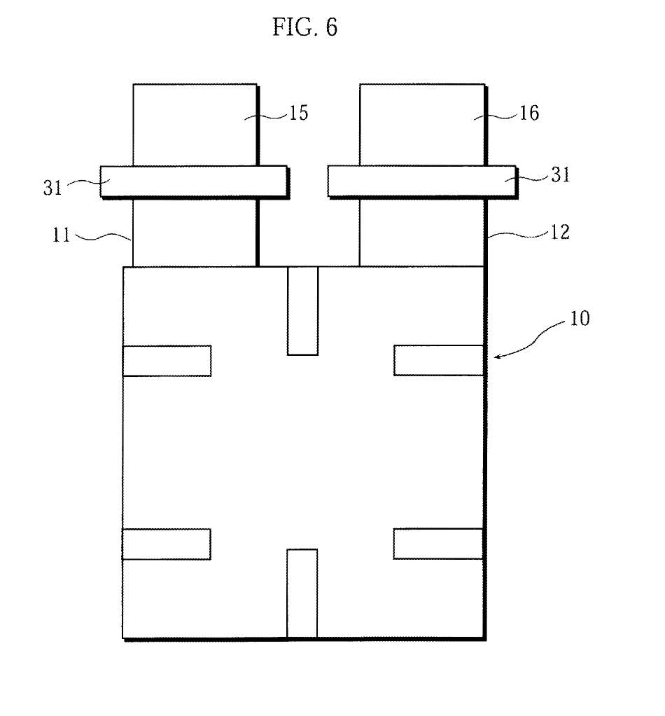

As illustrated in FIG. 6, a positive electrode current collector terminal 15 made of an aluminum plate having a width of 30 mm and a thickness of 0.4 mm and a negative electrode current collector terminal 16 made of a copper plate having a width of 30 mm and a thickness of 0.4 mm were welded respectively to the foremost ends of the positive electrode current collector tabs 11 and the foremost ends of the negative electrode current collector tabs 12 by ultrasonic welding.

Note that reference numeral 31 shown in FIG. 6 and other drawings denotes a resin sealing material (adhesive material), formed so as to be firmly bonded to each of the positive and negative electrode current collector terminals 15 and 16 in a strip shape along the widthwise direction, for ensuring hermeticity when heat-sealing a later-described battery case 18.

### Placing the Electrode Assembly in Battery Case

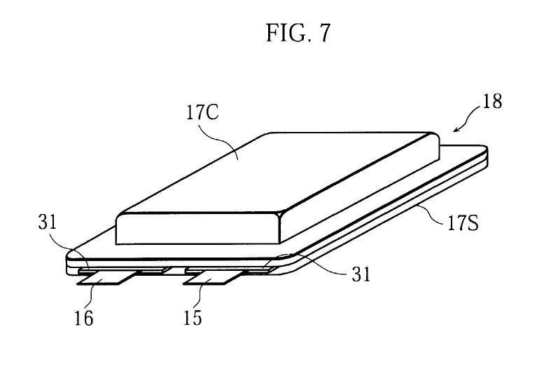

As illustrated in FIG. 7, the stacked electrode assembly 10 was inserted in a cup-shaped laminate 17C formed in a cup-like shape so as to enclose the electrode assembly, in such a manner that the positive electrode current collector terminal 15 and the negative electrode current collector terminal 16 protrude outside. The sheet-shaped laminate 17S was overlapped thereto, and the three sides thereof except for the side opposing the side from which the positive and negative electrode current collector terminals 15 and 16 protrude were thermally welded, to construct a laminate battery case 18 enclosing the stacked electrode assembly 10 therein. In this process, the stacked electrode assembly 10 was inserted in the laminate battery case 18 so that the stacking direction-wise upper side of the stacked electrode assembly 10 (that is, the side in which the high blocking rate pouch-type separators 3H were used for the first to the fourth stacks) faces the sheet-shaped laminate 17S side.

### Preparation of Electrolyte Solution

A lithium salt LiPF₆ was dissolved at a concentration of 1 M (mole/L) in a mixed solvent of 30:70 volume ratio of ethylene carbonate (EC) and methyl ethyl carbonate (MEC) to prepare an electrolyte solution. The resultant electrolyte solution had a viscosity of 2.0 mPa·s.

### Filling Electrolyte Solution and Sealing the Battery Case

The battery was held in such a manner that the side of the laminate battery case 18 from which the positive and negative electrode current collector terminals 15 and 16 protrude faced downward, and 150 mL of the above-described electrolyte solution was filled therein from one side (the upper side) that was not yet thermally welded. Next, decompression was performed three times, each for 15 minutes, while holding the laminate battery case 18 so that the cup-shaped laminate 17C faced downward. Lastly, the one side that was not yet thermally welded was thermally welded, to thus complete a battery.

### EXAMPLES

### Example 1

A stack type battery fabricated in the same manner as described in the foregoing embodiment was used as the stack type battery of this example.

The battery fabricated in this manner is hereinafter referred to as Battery A1 of the invention.

### Comparative Example 1

A stack type battery was fabricated in the same manner as described in the foregoing Battery A1 of the invention, except that all the 25 sheets of the pouch-type separators 3 of the stacked electrode assembly 10 were the high blocking rate pouch-type separators 3H.

The battery fabricated in this manner is hereinafter referred to as Comparative Battery Z1.

### Comparative Example 2

A stack type battery was fabricated in the same manner as described in the foregoing Battery A1 of the invention, except that all the 25 sheets of the pouch-type separators 3 of the stacked electrode assembly 10 were the low blocking rate pouch-type separators 3L.

The battery fabricated in this manner is hereinafter referred to as Comparative Battery Z2.

### Evaluation of the Batteries (Study of Dispersibility of Electrolyte Solution)

### Measurement of Weight of Positive Electrode

In the fabrication process of each of Battery A1 of the invention and Comparative Batteries Z1 and Z2, the laminate battery case 18 was disassembled and the insulating tapes 26 fixing the stacked electrode assembly 10 were removed while the cup-shaped laminate 17C of the laminate battery case 18 was kept facing downward, at the stage before the one side of the laminate battery case 18 that had not yet been thermally welded would lastly be thermally welded. The weight of each of the positive electrode plates 1 was measured one by one, from the upper stack portion of the stacked electrode assembly 10.

### Results

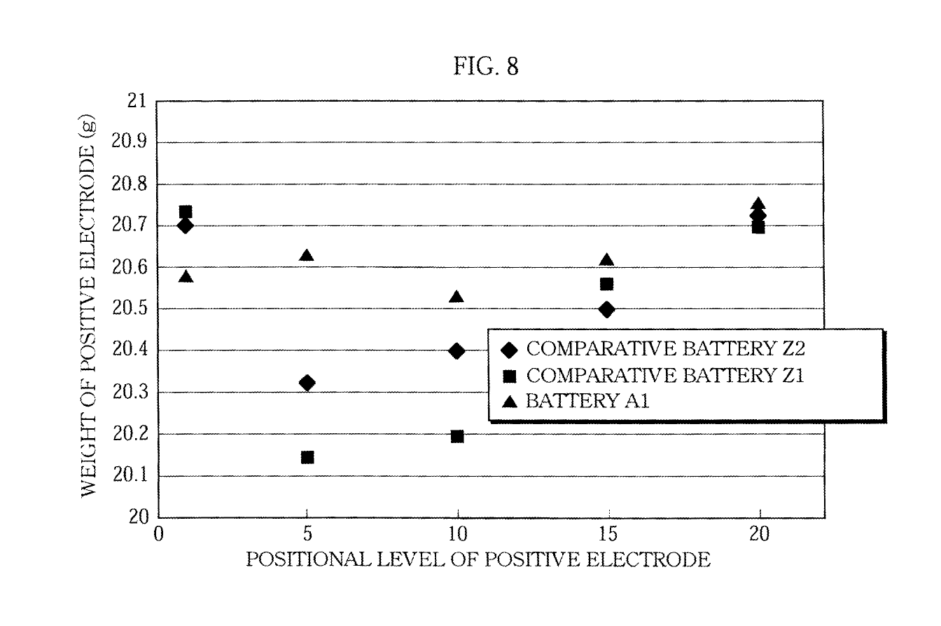

The results of the above-described measurement are shown in FIG. 8. As clearly seen from FIG. 8, the dispersibility of the electrolyte solution (i.e., the electrolyte permeation) for each of Battery A1 of the invention and Comparative Batteries Z1 and Z2 was as follows.

Comparative Battery Z1: The weight of the positive electrode plate 1 decreases considerably in the stacking direction-wise central portion and a portion slightly thereabove of the stacked electrode assembly 10. This indicates that the electrolyte permeation was insufficient in these portions.

Comparative Battery Z2: The decrease of the weight of the positive electrode plate 2 is still large, although it is alleviated somewhat. This indicates that although the electrolyte permeation was slightly improved, the improvement was still insufficient.

Battery A1 of the invention: The decrease of the weight of the positive electrode plate 1 is significantly lessened in the stacking direction-wise central portion and also the portion slightly thereabove of the stacked electrode assembly 10. This indicates that the electrolyte permeation was improved to a sufficient level.

### Analysis

The improvement effect in electrolyte permeation is less for Comparative Battery Z2 (Comparative Example 2), in which the welded portion was set smaller (30%) for all the pouch-type separators 3 in the stacked electrode assembly 10. The reason is believed to be that the overall balance of the electrolyte permeation is not improved, and the electrolyte remains to be difficult to permeate into the portion along the stacking direction of the stacked electrode assembly 10 in which the electrolyte is difficult to permeate, that is, the stacking direction-wise central portion. In other words, by improving the permeability of the electrolyte solution uniformly for all the pouch-type separators 3 of the stacked electrode assembly 10, it is impossible to eliminate the unevenness of the permeability of the electrolyte solution resulting from the difference in the locations of the separators between the stacking direction-wise central portion and both stacking direction-wise end portions, and the electrolyte solution merely infiltrates more intensively into both end portions, in which the electrolyte solution is allowed to enter more easily, rather than the central portion, in which the electrolyte solution is difficult to enter.

In contrast, the electrolyte permeation is improved effectively in Battery A1 of the invention (Example 1), in which the portion in which the electrolyte solution easily permeates, in other words, the welded portion of each of the pouch-type separators 3 located in both stacking direction-wise end portions, is made larger (80%) so that the electrolyte solution can be difficult to permeate therein, while the portion in which the electrolyte solution is difficult to permeate, in other words, the welded portion of each of the pouch-type separators 3 located in the stacking direction-wise central portion, is made smaller (30%) so that the electrolyte solution can be more easy to permeate therein. In this way, by controlling the proportion of the welded portion in the pouch-type separator 3 along a stacking direction in such a manner that the permeability of the electrolyte solution can be improved only for the pouch-type separators 3 in the central portion in which the electrolyte solution is originally difficult to permeate, it becomes possible to reduce (or uniformize) the unevenness of the permeability of the electrolyte solution resulting from the difference in the position of the separator between the stacking direction-wise central portion and both stacking direction-wise end portions. Thereby, it becomes possible to infiltrate the electrolyte solution in the electrode plates uniformly.

Advantageous Effects obtained by Battery A1 of the Invention

The above-described Battery A1 of the invention comprises a stacked electrode assembly 10 comprising a plurality (25 sheets) of positive electrode plates 1 having respective positive electrode current collector tabs 11 protruding therefrom, a plurality (26 sheets) of negative electrode plates 2 having respective negative electrode current collector tabs 12 protruding therefrom, and separators 3a interposed between the positive electrode plates 1 and the negative electrode plates 2, the positive electrode plates 1 and the negative electrode plates 2 being alternately stacked one another across the separators 3a. Each one of pairs of the separators 3a adjacent to each other in a stacking direction has a bonded portion 4 in which the adjacent separators 3a are bonded to each other in at least a portion of a perimeter portion thereof, to form a pouch-type separator 3. The proportion (30%) of the bonded portion 4 of each one of the pouch-type separators 3, the low blocking rate pouch-type separators 3L, located in the fifth to 15th stacks from the top, which is the stacking direction-wise central region of the stacked electrode assembly 10, is made smaller than the proportion (80%) of the bonded portion 4 of each of the pouch-type separators 3, the high blocking rate pouch-type separators 3H, located in the first to fourth stacks and the 16th to 25th stacks from the top, which are both stacking direction-wise end portions of the stacked electrode assembly 10.

In the above-described Battery A1 of the invention, the proportion of the bonded portion 4 (i.e., the welded portion) is controlled to be large (80%) in the high blocking rate pouch-type separators 3H located in the stacking direction-wise upper stacks and lower stacks (both stacking direction-wise end portions) of the stacked electrode assembly 10, in which the electrolyte solution easily permeates normally, while the proportion of the bonded portion 4 (i.e., the welded portion) is controlled to be small (30%) in the low blocking rate pouch-type separators 3L located in the stacking direction-wise central portion of the stacked electrode assembly, in which the electrolyte solution is normally difficult to permeate. As a result, unevenness of the permeability of the electrolyte solution along the stacking direction is alleviated, and the distribution of the electrolyte solution is uniformized. In other words, the electrolyte permeation in the stacked electrode assembly 10 is uniformized across the stacking direction effectively.

Moreover, the proportion of the bonded portion 4 (i.e., the welded portion) of each of the low blocking rate pouch-type separators 3L located in the stacking direction-wise central region of the stacked electrode assembly 10 is set to 30%, i.e., less than 50%. Therefore, the permeability of the electrolyte solution is sufficient in the stacking direction-wise central region of the stacked electrode assembly 10. As a result, unevenness of the permeability of the electrolyte solution along the stacking direction can be alleviated effectively.

In addition, the fifth to the 15th stacks from the top of the stacked electrode assembly 10, which is the stacking direction-wise central region of the stacked electrode assembly 10, deviates (is shifted) from the stacking direction-wise center, i.e., the position of the 13th stack, toward one stacking direction-wise end, i.e., upward. As a result, when the battery is held in a horizontal orientation (the orientation in which the stacking direction is a vertical direction), the electrolyte solution can permeate and diffuse effectively in the electrode plate 1 disposed between the separators 3a located in a region slightly above the center of the stacked electrode assembly 10 (i.e., the electrode plate 1 enclosed in the pouch-type separator 3), in which the electrolyte solution is originally difficult to permeate.

The proportion 30% of the bonded portion 4 of each one of the low blocking rate pouch-type separators 3L located in the fifth to 15th stacks from the top, which are included in the 20-60% region from the top side, i.e., from one stacking direction-wise end of the stacked electrode assembly 10, is made smaller than the proportion 80% of the bonded portion 4 of each of the high blocking rate pouch-type separators 3H located in the first to fourth stacks and the 16th to 25th stacks from the top, which are included in a region other than the 20-60% region. In the 20-60% region from the top side, i.e., from the one stacking direction-wise end of the stacked electrode assembly 10, the electrolyte solution is especially difficult to permeate when the battery is held in a horizontal orientation. Thus, because the proportion 30% of the bonded portion 4 of the low blocking rate pouch-type separators 3L located in this region is made smaller than the proportion 80% of the bonded portion 4 of the high blocking rate pouch-type separators 3H located in a region other than the 20-60% region, the electrolyte permeation can be uniformized across the stacking direction of the stacked electrode assembly 10 effectively.

### Other Embodiments

(1) In the above-described Battery A1 of the invention, the respective proportions of the bonded portions 4 of the low blocking rate pouch-type separator 3L and the high blocking rate pouch-type separator 3H are set to 30% and 80%, respectively. However, it is desirable that the proportion of the bonded portion of each of the low blocking rate pouch-type separators be less than 50%, more preferably from about 10% to about 40%. It is also desirable that the proportion of the bonded portion of each of the high blocking rate pouch-type separators be 50% or greater, more preferably from about 60% to about 90%.

When the proportion of the bonded portion in each of the low blocking rate pouch-type separators is 10% or greater, the bonding strength in the bonded portion can be ensured. At the same time, when the proportion of the bonded portion in each of the low blocking rate pouch-type separators is less than 50%, more preferably 40% or less, the proportion of the bonded portion is sufficiently small so that the effect of uniformizing the electrolyte permeation can be obtained sufficiently. On the other hand, when the proportion of the bonded portion in each of the high blocking rate pouch-type separators is 50% or greater, more preferably 60% or greater, the proportion of the bonded portion is sufficiently large and the effect of uniformizing the electrolyte permeation can be obtained sufficiently. At the same time, when the proportion of the bonded portion in each of the high blocking rate pouch-type separators is 90% or less, it is possible to avoid the problem that the electrolyte solution is excessively difficult to permeate in both stacking direction-wise end portions.

(2) In the above-described Battery A1 of the invention, the bonded portion 4 of the pouch-type separator 3 is formed by thermal welding. However, it is also possible to use other methods than thermal welding, such as ultrasonic welding and bonding using an adhesive agent, as the bonding method for forming the bonded portion.

(3) In the above-described Battery A1 of the invention, the laminate battery case 18 comprises the cup-shaped laminate 17C, which is the cup-shaped portion formed so as to enclose the stacked electrode assembly, and the sheet-shaped laminate 17S, which is the sheet-shaped portion, and the stacking direction-wise central region of the stacked electrode assembly 10 deviates (or is shifted) from the stacking direction-wise center of the stacked electrode assembly toward the sheet-shaped laminate 17S side. However, the stacking direction-wise central region of the stacked electrode assembly 10 may deviate (or be shifted) from the stacking direction-wise center of the stacked electrode assembly toward the cup-shaped laminate 17C side. With this configuration, it is suitable to set the cup-shaped laminate 17C side to be the upper side, and the battery tends to be more stable when the battery is laid in a horizontal orientation after filling the electrolyte solution.

(4) The positive electrode active material is not limited to lithium cobalt oxide. Other usable materials include lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

(5) Other than the graphite such as natural graphite and artificial graphite, various materials may be employed as the negative electrode active material as long as the material is capable of intercalating and deintercalating lithium ions. Examples include coke, tin oxides, metallic lithium, silicon, and mixtures thereof.

(6) The electrolyte is not limited to that shown in the example above, and various other substances may be used. Examples of the supporting salt include LiBF₄, LiPF₆, LiN(SO₂CF₃)₂, LiN(SO₂C₂F₅)₂, and LiPF_{6-X}(CₙF₂ₙ₊₁)_{X} (wherein 1≦x≦6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. The types of the solvents are not particularly limited to EC and MEC mentioned above. Examples of preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

The present invention is suitably applied to, for example, power sources for high-power applications, such as backup power sources and power sources for the motive power incorporated in robots and electric automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A stack type battery comprising:
a stacked electrode assembly comprising a plurality of positive electrode plates having respective positive electrode current collector tabs protruding therefrom, a plurality of negative electrode plates having respective negative electrode current collector tabs protruding therefrom, and separators interposed between the positive electrode plates and the negative electrode plates, the positive electrode plates and the negative electrode plates being alternately stacked one another across the separators; wherein:
each one of pairs of the separators adjacent to each other in a stacking direction has a bonded portion in which the adjacent separators are bonded to each other in at least a portion of a perimeter portion thereof; and
the proportion of the bonded portion of one of the separators located in a stacking direction-wise central region of the stacked electrode assembly is smaller than the proportion of the bonded portion of each of the separators located in both stacking direction-wise end portions of the stacked electrode assembly.

2. The stack type battery according to claim 1, wherein the proportion of the bonded portion of the one of the separators located in the stacking direction-wise central region of the stacked electrode assembly is less than 50%.

3. The stack type battery according to claim 1, wherein the stacking direction-wise central region of the stacked electrode assembly deviates from the stacking direction-wise center toward one stacking direction-wise end of the stacked electrode assembly.

4. The stack type battery according to claim 2, wherein the stacking direction-wise central region of the stacked electrode assembly deviates from the stacking direction-wise center toward one stacking direction-wise end of the stacked electrode assembly.

5. The stack type battery according to claim 3, wherein the proportion of the bonded portion of one of the separators located in at least a portion of a 20-60% region from one stacking direction-wise end of the stacked electrode assembly is smaller than the proportion of each of the bonded portions of the separators located in a region other than the 20-60% region.

6. The stack type battery according to claim 4, wherein the proportion of the bonded portion of one of the separators located in at least a portion of a 20-60% region from one stacking direction-wise end of the stacked electrode assembly is smaller than the proportion of each of the bonded portions of the separators located in a region other than the 20-60% region.

7. The stack type battery according to claim 5, wherein the proportion of the bonded portion of one of the separators located in at least a portion of a 25-50% region from one stacking direction-wise end of the stacked electrode assembly is smaller than the proportion of each of the bonded portions of the separators located in a region other than the 25-50% region.

8. The stack type battery according to claim 6, wherein the proportion of the bonded portion of one of the separators located in at least a portion of a 25-50% region from one stacking direction-wise end of the stacked electrode assembly is smaller than the proportion of each of the bonded portions of the separators located in a region other than the 25-50% region.

9. The stack type battery according to claim 1, wherein the stacked electrode assembly is accommodated in a laminate battery case made of a laminate film.

10. The stack type battery according to claim 2, wherein the stacked electrode assembly is accommodated in a laminate battery case made of a laminate film.

11. The stack type battery according to claim 9, wherein the laminate battery case comprises a sheet-shaped portion and a cup-shaped portion formed so as to enclose the stacked electrode assembly, and the stacking direction-wise central region of the stacked electrode assembly deviates from the stacking direction-wise center of the stacked electrode assembly toward the cup-shaped portion.

12. The stack type battery according to claim 10, wherein the laminate battery case comprises a sheet-shaped portion and a cup-shaped portion formed so as to enclose the stacked electrode assembly, and the stacking direction-wise central region of the stacked electrode assembly deviates from the stacking direction-wise center of the stacked electrode assembly toward the cup-shaped portion.

13. The stack type battery according to claim 9, wherein the laminate battery case comprises a sheet-shaped portion and a cup-shaped portion formed so as to enclose the stacked electrode assembly, and the stacking direction-wise central region of the stacked electrode assembly deviates from the stacking direction-wise center of the stacked electrode assembly toward the sheet-shaped portion.

14. The stack type battery according to claim 10, wherein the laminate battery case comprises a sheet-shaped portion and a cup-shaped portion formed so as to enclose the stacked electrode assembly, and the stacking direction-wise central region of the stacked electrode assembly deviates from the stacking direction-wise center of the stacked electrode assembly toward the sheet-shaped portion.

15. The stack type battery according to claim 1, wherein each of the positive electrode plates has an area of 200 cm² or greater.

16. The stack type battery according to claim 2, wherein each of the positive electrode plates has an area of 200 cm² or greater.

17. The stack type battery according to claim 1, wherein the bonded portions are formed by welding.

18. The stack type battery according to claim 2, wherein the bonded portions are formed by welding.

19. The stack type battery according to claim 1, further comprising an electrolyte solution having a viscosity of 2.0 mPa·s or greater.

20. The stack type battery according to claim 2, further comprising an electrolyte solution having a viscosity of 2.0 mPa·s or greater.
